(19) United States
(12) Patent Application Publication
(10) Pub. No.: US 2026/0359105 A1
(43) Pub. Date: Nov. 12, 2026

(54) COMPATIBILITY-BASED HANDOFF OF ARTIFICIAL INTELLIGENCE (AI) COMMANDS BETWEEN GENERAL AI EXECUTION ENVIRONMENTS AND APPLICATION-NATIVE AI AGENTS

(71) Applicant: Dorian Cartwright, San Jose, CA (US)

(72) Inventor: Dorian Cartwright, San Jose, CA (US)

(21) Appl. No.: 19/707,354

(22) Filed: Jun. 14, 2026

Related U.S. Application Data
(63) Continuation-in-part of application No. 19/696,219, filed on Jun. 2, 2026.
Application No. 19/696,219 is a continuation-in-part of application No. 19/667,591, filed on May 4, 2026.
Application No. 19/667,591 is a continuation-in-part of application No. 19/664,886, filed on Apr. 30, 2026.
Application No. 19/664,886 is a continuation-in-part of application No. 19/658,054, filed on Apr. 24, 2026.
Application No. 19/658,054 is a continuation-in-part of application No. 19/630,125, filed on Mar. 26, 2026.
(60) Provisional application No. 63/970,881, filed on Jan. 29, 2026.
(60) Provisional application No. 63/978,933, filed on Feb. 9, 2026.
(60) Provisional application No. 64/002,939, filed on Mar. 11, 2026.

(51) Int. Cl. G06F 9/48; G06F 9/54; G06F 21/55; G06N 5/043

(52) U.S. Cl. CPC G06F 9/4875; G06F 9/546; G06F 21/554; G06N 5/043

(57) ABSTRACT

An artificial intelligence command handoff system detects incompatibility between a task and a current execution path and transfers the task to a compatible artificial intelligence execution environment. In a forward direction, a conversational assistant may determine that a valid user command requires native application capability unavailable through a current interface, generate a delegated command package, and route the package to an application-native artificial intelligence agent. In a reverse direction, an application-native artificial intelligence agent may determine that a task requires a model capability unavailable to the native agent, generate an outsourced task package, and route the package to an external model. Returned results are validated and reconciled with conversational or application state. In some embodiments, a validation layer intercepts commands, classifies incompatibility, and selects among allowing, blocking, rewriting, sandboxing, delegating, outsourcing, or rolling back the command.

### CROSS-REFERENCE TO RELATED APPLICATIONS

This application claims priority under 35 U.S.C. 120(a) as a continuation-in-part of U.S. patent application Ser. No. 19/696,219, filed Jun. 2, 2026, entitled STATEFUL BRANCHING AND MULTI-VARIANT GENERATION FOR CONVERSATIONAL MEDIA CREATION, by Dorian Cartwright, the entire contents of which are incorporated herein by reference.

### FIELD OF THE INVENTION

The present disclosure relates generally to computers and artificial intelligence, and more specifically, to detecting incompatibility between an artificial intelligence command and a current execution environment, transferring a command or task between artificial intelligence execution environments, and reconciling results across conversational assistants.

### BACKGROUND

Artificial intelligence assistants can interpret natural language instructions, generate tool calls, invoke application programming interfaces, call external services, and coordinate multi-step workflows. However, a first artificial intelligence system often has user intent and conversational context without having sufficient authority or native application state to complete a requested operation. For example, a general chat assistant may determine that a content-management-system field exists in a website builder, but lack authority to bind that field to a visual page element in the website builder editor. A general assistant may draft a video edit plan but lack access to a media timeline, generate product-copy instructions but lack checkout configuration authority, or generate a design instruction but lack access to a native design canvas.

Application-native artificial intelligence agents are increasingly embedded inside software applications. A native application agent may access a visual editor, media timeline, design canvas, project file, recommendation engine, checkout system, unpublished draft state, local session state, integrated development environment, native safety validator, or other application-specific actuator unavailable to a general assistant. However, the native application agent may lack broader model capability, long-context reasoning, cross-application context, legal or technical drafting ability, natural-language planning depth, multimodal interpretation capability, or access to an external foundation model. The native agent may therefore be able to execute inside the application but still need to outsource reasoning, content generation, code generation, summarization, classification, retrieval, or planning to another model.

Conventional integrations do not adequately address this bidirectional capability separation. When a general assistant cannot complete a task, it may merely present manual instructions. When an application-native agent lacks model capability, it may fail, produce a weak result, or call an external model without preserving application policy, user authorization, target-object state, output schema, privacy limits, or execution responsibility. Likewise, existing command firewalls often allow, block, or audit commands without resolving valid-but-incompatible commands by routing them to a more suitable artificial intelligence execution environment.

The technical problem is not merely opening another application or invoking another model. The technical problem is how to determine that a proposed command or task remains valid in user intent but incompatible with a current execution path, classify the missing capability, generate a structured package containing task state and constraints, transfer the package to an appropriate artificial intelligence execution environment, validate the returned result, and reconcile or execute the result while preserving authorization, policy, lineage, rollback, and conversational continuity.

Accordingly, there is a need for robust compatibility-based handoff between artificial intelligence execution environments.

### SUMMARY

These shortcomings are addressed in the present disclosure with systems, methods, and computer program products for validation-layer and compatibility-based handoff of artificial intelligence commands. A first artificial intelligence execution environment receives or generates a command, task, or proposed operation. The system determines that the command or task is incompatible with a current execution path but compatible with a second artificial intelligence execution environment or native application capability. A handoff package is generated and transferred to the second environment. A result is returned, validated, reconciled, executed, previewed, or used to update an original conversational or application state.

In a forward handoff embodiment, a general conversational assistant, operating-system assistant, browser assistant, cloud workflow agent, or other external assistant has semantic understanding of a user instruction and may complete some sub-operations, but lacks native application authority for a remaining sub-operation. The system detects an execution-interface incompatibility, generates a delegated command package, and transfers the unresolved sub-operation to an application-native artificial intelligence agent. The application-native agent executes, previews, or drafts the native operation using application state or actuators unavailable to the first assistant, and returns a result to the first assistant or an intermediary service.

In a reverse handoff embodiment, an application-native artificial intelligence agent has native application state and execution authority but lacks a required model capability. The native agent, an intermediary validation layer, or another compatibility manager detects model-capability incompatibility and generates an outsourced model task package for an external large language model, foundation model, domain model, multimodal model, local model, enterprise model, or other second artificial intelligence execution environment. The external model returns a structured model result, such as a plan, proposed edit, command template, generated text, code fragment, semantic classification, validation result, ranked alternative set, or reasoning artifact. The native application agent or validation layer validates the result and performs any native execution using native application authority.

In a validation-layer embodiment, a validation layer is disposed between a chat artificial intelligence system and one or more underlying applications, tool interfaces, native agents, or external models. The validation layer intercepts proposed commands and evaluates safety, authorization, policy, syntax, semantic compatibility, target-object availability, execution-interface compatibility, model-capability compatibility, privacy constraints, side effects, and confirmation requirements. The validation layer may allow, block, rewrite, decompose, sandbox, branch, request confirmation, delegate to an application-native agent, or outsource to an external model. The validation layer may therefore function as both a command firewall and a compatibility resolver.

The transfer can also occur outside the validation layer. In some embodiments, the first assistant performs compatibility detection directly. In other embodiments, a tool adapter, browser extension, operating-system service, cloud broker, application endpoint, workflow engine, local daemon, model-context server, or application-native agent performs detection and transfer. The validation-layer architecture is therefore one embodiment and not a required limitation of all claims.

The handoff package may include user intent, a normalized command representation, source and destination artificial intelligence environment identifiers, target application identifiers, target-object identifiers, completed sub-operations, partial execution traces, missing capability classifications, required native capabilities, required model capabilities, execution constraints, privacy constraints, output-format requirements, authorization scopes, rollback instructions, success criteria, validation rules, lineage metadata, policy metadata, branch state, and a return channel. A result package may include completion status, partial completion status, a structured result, a preview, screenshot, diff, model output, validation outcome, failure reason, rollback token, audit identifier, or confirmation request.

Many other variations are possible.

### BRIEF DESCRIPTION OF FIGURES

The present disclosure will be understood more fully from the detailed description given below and from the accompanying drawings of various embodiments of the disclosure.

FIG. 1 is a perspective diagram of artificial intelligence command handoff, according to an embodiment.

FIG. 2 is a block diagram illustrating a network architecture of artificial intelligence command handoff system, according to an embodiment.

FIG. 3 is a more detailed block diagram illustrating a handoff management engine, according to an embodiment.

FIG. 4A is a sequence diagram illustrating forward handoffs to an application-native artificial intelligence agent from an external model; and FIG. 4B illustrates reverse handoffs from an application-native artificial intelligence agent to an external model, according to an embodiment.

FIG. 5 is a schematic diagram illustrating a handoff package structure, according to an embodiment.

FIG. 6 is a block diagram illustrating a computing environment for implementing bidirectional artificial intelligence command handoff, according to an embodiment.

FIG. 7 illustrates a method for forward handoff from a conversational or external artificial intelligence assistant to an application-native artificial intelligence agent, according to an embodiment.

FIG. 8 illustrates a method for reverse handoff from an application-native artificial intelligence agent to an external model or comparable artificial intelligence execution environment, according to an embodiment.

FIG. 9 illustrates a method for validation-layer command interception and compatibility-based resolution of proposed artificial intelligence commands, according to an embodiment.

FIG. 10 illustrates a method for compatibility-based handoff with validation and reconciliation of returned results, according to an embodiment.

### DETAILED DESCRIPTION

The description below provides systems, methods, and computer program products for bidirectional artificial intelligence handoff. The disclosure is directed to compatibility-based transfer of a command, task, state package, or model request between artificial intelligence execution environments. Although examples may refer to website builders, video editors, music services, design tools, commerce platforms, document editors, development environments, operating systems, robotics systems, and large language models, the disclosure is not limited to any particular application type, model type, or communication protocol.

### I. Systems for Compatibility-Based and Bidirectional AI Environment Handoff

### A. Overall AI Agent Handoff Architecture

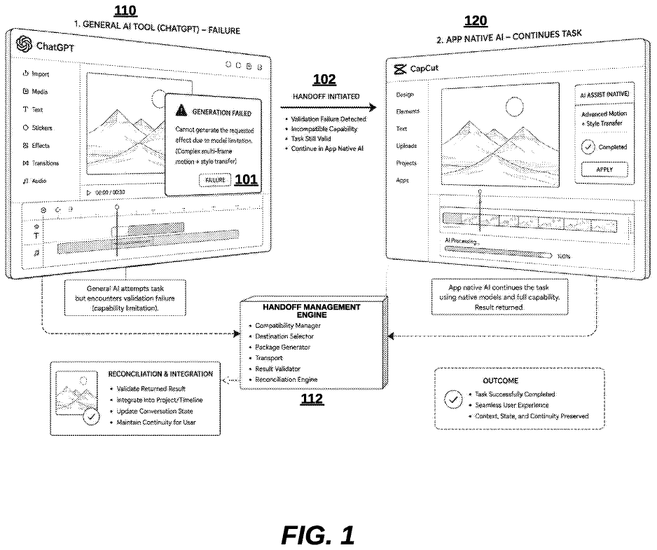

FIG. 1 illustrates an AI agent handoff system, according to an embodiment. The system 100 includes a source artificial intelligence execution environment 110, a handoff management engine 112, one or more destination artificial intelligence execution environments 120. The source artificial intelligence execution environment 110 may be a general conversational assistant, a chatbot, a browser assistant, an operating system assistant, a workflow agent, a cloud orchestration agent, a local model, a remote model, an application-native artificial intelligence agent, a media editor agent, a website builder agent, a commerce agent, an integrated development environment agent, a robotics controller agent, or another artificial intelligence runtime.

The destination artificial intelligence execution environment 120 may likewise be a general assistant, an application native agent, an external large language model, a domain specific model, a local model, an enterprise model, a multimodal model, a code model, a recommendation model, a safety classifier, a planning model, a validation model, an operating system service, a target application endpoint, or another artificial intelligence runtime. The handoff architecture is bidirectional because either a general assistant may transfer an unresolved operation to an application-native agent, or an application-native agent may transfer a reasoning or generation task to an external model.

In a first direction, the source environment 110 has user intent, conversation state, partial execution state, and cross-application context but lacks a native application capability. For example, the source environment 110 may have identified a target website, confirmed a content management system field, and determined that a visual binding is needed, while lacking authority to modify the visual website editor. The system therefore transfers the unresolved operation to a destination environment 120 that is native to the target application. A result can be returned back to the source artificial intelligence execution environment 110, or alternatively, a result can remain within the destination environment 120 for continuation.

In a second direction, the source environment 110 is an application-native artificial intelligence agent with access to native application state, project files, sessions, timelines, canvases, editors, transaction systems, or actuator authority. The native agent may lack a model capability needed for the task, such as long-context reasoning, legal drafting, technical drafting, code generation, semantic classification, multimodal interpretation, retrieval-augmented reasoning, policy analysis, or natural-language planning. The system therefore transfers a reduced or structured model task to an external model or other destination environment 120. As with the first direction, a result can remain for continued execution or be returned. A returned result is received and validated, and then executed in any native application operation locally within the source application.

In some embodiments, the source artificial intelligence execution environment and the destination artificial intelligence execution environment may each execute locally, remotely, in a cloud service, in an edge device, in a browser runtime, in an operating-system service, in a native application, in a mobile application, in a local accelerator, or in a distributed combination thereof. Accordingly, a handoff may occur from a cloud-hosted general assistant to a local application-native artificial intelligence agent, from a cloud-hosted general assistant to a cloud-hosted application-native artificial intelligence agent, from a locally executing general artificial intelligence model to a local application-native artificial intelligence agent, or from a locally executing general artificial intelligence model to a cloud-hosted application-native artificial intelligence agent.

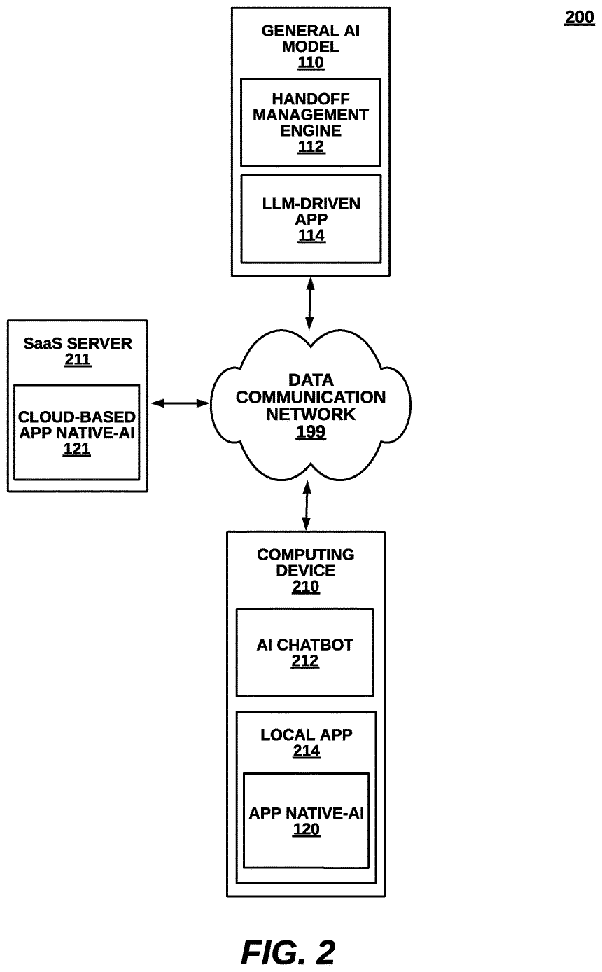

FIG. 2 is a block diagram illustrating a network architecture of artificial intelligence command handoff system 200, according to an embodiment. The system 200 includes a general AI model 110, and one or both of a computing device 210 and a SaaS server 211, each coupled in communication through a data communication network 299.

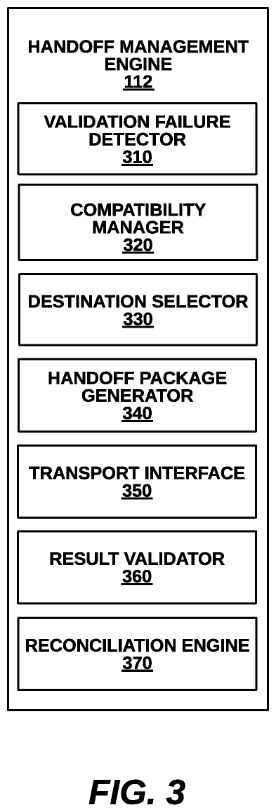

FIG. 3 is a more detailed block diagram illustrating the handoff management engine 112, according to an embodiment. The handoff management engine 112 further comprises a validation failure detector 310, a compatibility manager 320, a destination selector 330, a handoff package generator 340, a transport interface 350, a result validator 360, and a reconciliation engine 370. Many variations are possible.

The compatibility manager 320 may evaluate a task, proposed command, model request, tool call, branch instruction, natural-language instruction, or application operation against capability profiles associated with available execution interfaces. The compatibility manager 120 may determine whether the current path can complete the operation, whether another path can complete the operation, and whether the operation should be allowed, rewritten, decomposed, sandboxed, branched, delegated, outsourced, blocked, or held for user confirmation.

The handoff package generator 140 may form a machine-readable package. The package may be represented as JSON, XML, protocol buffers, a typed function call, an application intent, a model-context protocol message, a deep link payload, an event-stream object, a signed token, a project-file patch, a workflow object, a task graph, a branch-consistent state package (e.g., kv cache values), or another transportable representation. The package may be transmitted using an application programming interface, local inter-process communication, browser extension bridge, operating-system service, plug-in interface, cloud message queue, event bus, webhook, deep link, model-serving API, remote procedure call, or other communication path.

The result validator 160 may validate returned output before execution, publication, display, or conversational reconciliation. Validation may include schema validation, policy validation, authorization validation, target-object validation, success-criteria validation, confidence validation, harmful-action validation, privacy validation, hallucination validation, formatting validation, or user-confirmation checks. The reconciliation engine 170 may update a conversation, tool state, application state, lineage graph, audit log, branch state, or user interface based on the result.

### B. Compatibility Detection, Validation Layer, and Resolution Actions

In some embodiments, a validation layer 130 is disposed between a chat artificial intelligence system and one or more underlying applications, tool interfaces, native agents, or external models. The validation layer 130 intercepts proposed commands before the commands are executed by an application, transmitted to an external model, committed to public content, used for a transaction, exported to a file, or used to control a device.

The validation layer 130 may evaluate the proposed command for safety, authorization, policy compliance, syntactic validity, semantic validity, target-object availability, execution-interface compatibility, model-capability compatibility, application-state availability, output-format compatibility, likely side effects, privacy sensitivity, confirmation requirements, and rollback availability. The validation layer 130 may therefore identify commands that are unsafe, unauthorized, ill-formed, unsupported, or inconsistent with user intent. The validation layer 130 may also identify commands that are safe and semantically valid but incompatible with the current execution path.

The phrase valid intent but incompatible execution path refers to a condition in which a command correctly expresses a user-requested operation but cannot be completed by the currently available interface. For example, an assistant may know that a filing-date field should be exposed on a dynamic page, but the current API may allow only collection inspection rather than page-canvas binding. The validation layer 130 may classify the command as valid in intent and native-agent-resolvable, rather than treating the command as a failure.

Incompatibility may include schema incompatibility, permission incompatibility, visual-editor incompatibility, timeline-editor incompatibility, canvas incompatibility, application-state incompatibility, native-recommendation incompatibility, version incompatibility, modality incompatibility, target-object incompatibility, output-format incompatibility, transaction-authority incompatibility, publication-state incompatibility, policy incompatibility, model-capability incompatibility, reasoning-depth incompatibility, context-window incompatibility, domain-knowledge incompatibility, privacy-policy incompatibility, confidence incompatibility, or another mismatch between the task and the current execution path.

Responsive to an incompatibility determination, the validation layer 130 may select among resolution actions. The resolution actions may include allowing the command through the current interface, blocking the command, rewriting the command, decomposing the command into compatible sub-commands, sandboxing the command, executing in preview mode, branching the command into alternative execution paths, requiring user confirmation, delegating an operation to an application-native artificial intelligence agent, outsourcing a model task to an external model, routing the task to a local model, routing the task to an enterprise model, or returning a structured failure reason.

The validation layer 130 may be implemented as a separate component or may be integrated into an operating system, browser, application, assistant runtime, tool adapter, model-context server, application firewall, enterprise governance layer, robotic safety layer, app store runtime, plug-in system, or cloud workflow system. The validation-layer embodiment is one embodiment. In other embodiments, compatibility detection and transfer are performed by the first assistant, the application-native agent, a tool adapter, a native application endpoint, a browser extension, an operating-system service, a cloud broker, a local daemon, or a workflow engine without a separate validation layer.

### C. Forward and Reverse Handoff Between Artificial Intelligence Environments

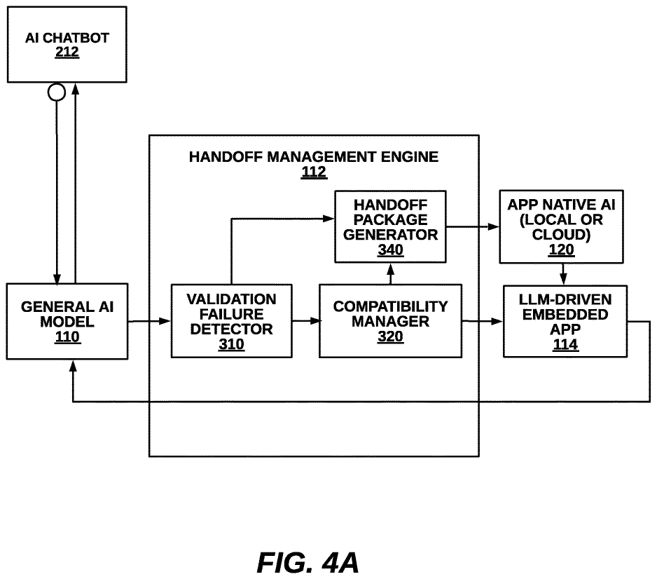

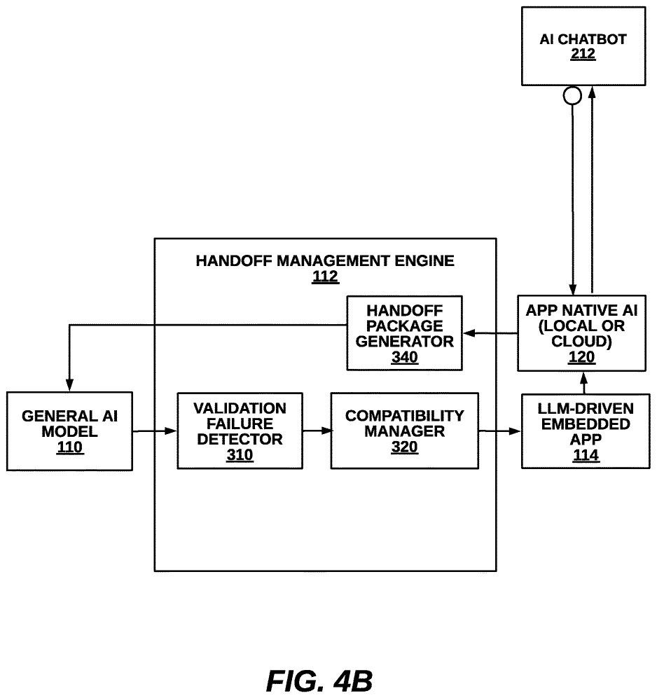

FIG. 4A illustrates forward handoff, according to an embodiment. In forward handoff, an AI chatbot 212, or alternatively, browser assistant, operating system agent, workflow agent, or other external artificial intelligence system receives a user instruction and performs partial work. The partial work may include identifying the target application, authenticating a user account, retrieving data, determining that a target object exists, inferring a desired change, forming a plan, generating an API call, executing compatible sub-operations, or collecting constraints. The system then detects an incompatibility for a remaining operation and generates a delegated command package for an application-native artificial intelligence agent.

The application-native artificial intelligent agent 120 may be embedded in, hosted by, or authorized by the target application. The native agent may access application state unavailable to the external assistant, such as a visual editor state, document cursor state, page layout tree, dynamic page binding model, media timeline, source media, subtitle track, audio track, design canvas, layer tree, recommendation engine, checkout configuration, product database, unpublished draft state, integrated development environment context, local project dependencies, robotic simulator, safety validator, or actuator controller. The native agent may execute the delegated operation, generate a preview, apply a draft, return a diff, request confirmation, commit a change, export an output, or return a failure reason.

FIG. 4B illustrates reverse handoff, according to an embodiment. In reverse handoff, an application-native artificial intelligence agent begins as the source environment. The native agent may have actuator authority within the target application but lack a model capability required for the task. The missing capability may include long-context reasoning, broad natural-language generation, legal drafting, patent drafting, code generation, technical explanation, semantic search, retrieval-augmented generation, translation, summarization, multimodal reasoning, image understanding, speech-to-text, text-to-speech planning, policy reasoning, safety classification, domain-specific analysis, ranking, or creative ideation.

Responsive to detecting the missing model capability, the native agent or an intermediary generates an outsourced model task package. The package may include a reduced representation of the user instruction, selected application state, target-object identifiers, relevant excerpts, privacy constraints, redaction instructions, output-format requirements, prohibited actions, success criteria, validation rules, and one or more requested model outputs. Sensitive application state may be redacted, summarized, transformed, hashed, tokenized, abstracted, or minimized before transfer.

The outsourced model task package is transmitted to an external large language model, foundation model, domain-specific model, multimodal model, code model, enterprise model, local model, or other second artificial intelligence execution environment. The second environment may return a structured model result, such as a plan, generated text, proposed edit, command template, ranked alternatives, code fragment, semantic classification, validation result, narrative, prompt, policy decision, or intermediate reasoning artifact. The native application agent or validation layer validates the structured model result before native execution. In one case, an LLM is contacted and prompted directly by a native AI agent. In another case, the app utilizes the handoff management engine 112, as in FIG. 4B.B.

In some embodiments, the external model does not have authority to directly mutate the source application. The external model supplies reasoning, content, analysis, planning, or structured outputs, while native execution remains under control of the application-native agent, validation layer, operating-system service, or user-confirmation process. This separation preserves application authority, privacy, and auditability.

### D. Handoff State, Policy, Provenance, and Reconciliation

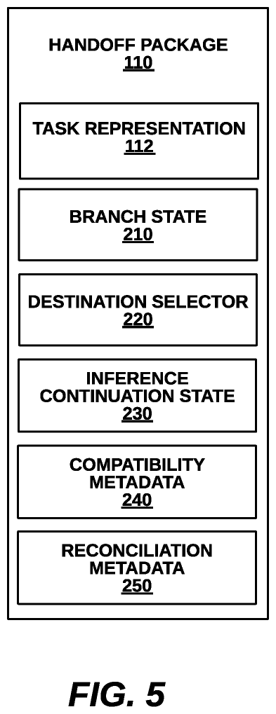

FIG. 5 illustrates an example handoff package structure, according to an embodiment. A handoff package may include a package identifier, source environment identifier, destination environment identifier, user identifier, application account identifier, target application identifier, target object identifier, workspace identifier, project identifier, session identifier, natural-language instruction, normalized intent representation, command representation, completed operations, unresolved operation, incompatibility type, required native capability, required model capability, execution constraints, privacy constraints, output-format requirements, authorization scope, expiration time, confirmation requirement, rollback instructions, success criteria, validation rules, lineage metadata, branch metadata, and return channel.

In some embodiments, the handoff package is a branch-consistent task state package. A shared-prefix task state may include the original user instruction, conversation context, target application identity, target object discovery, retrieved facts, completed sub-operations, authorization metadata, policy metadata, and common constraints. A branch-specific suffix state may include the unresolved native operation, delegated command, outsourced model task, model result, native execution result, preview, diff, or confirmation state. This allows the system to compare, replay, validate, continue, or merge multiple execution routes without duplicating common state.

The system may maintain a lineage graph. The lineage graph may represent relationships among user instructions, prompts, proposed commands, tool calls, completed sub-operations, incompatibility determinations, delegated packages, outsourced model packages, native agents, external models, model outputs, native operations, previews, diffs, commits, rollbacks, confirmations, exported files, and final outputs. The lineage graph may support audit, provenance, rollback, rights evaluation, privacy review, debugging, billing, model evaluation, enterprise compliance, and user navigation.

Policy and security metadata may travel with the handoff package. The metadata may restrict actions to preview mode, prohibit deletion, prohibit publication, require confirmation, limit target objects, limit time, restrict output destinations, redact sensitive data, require local model processing, require enterprise model processing, block public cloud processing, enforce data residency, require encryption, require signature verification, require human approval, or require rollback support.

Result reconciliation may include updating the original assistant conversation, updating a target application state, displaying a preview, presenting a diff, asking for confirmation, committing a native change, storing a model result, triggering another branch, merging results from multiple environments, retrying with another environment, or returning a structured failure reason. Reconciliation may be performed by the first assistant, application-native agent, validation layer, operating-system service, app broker, workflow engine, or another component.

### E. Computing Environment

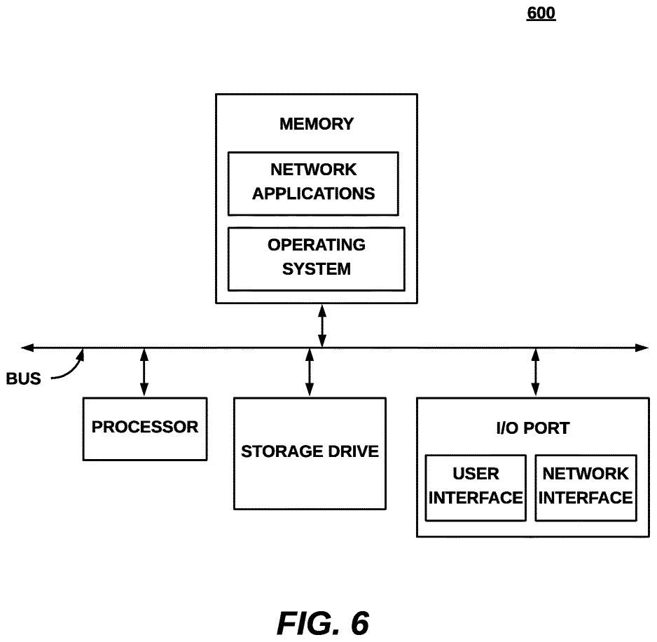

FIG. 6 illustrates a computing environment 600 configured to perform one or more operations described herein, according to an embodiment. The computing environment 600 may include one or more processors, graphics processing units, neural processing units, tensor processors, digital signal processors, media encoders, mobile processors, edge processors, servers, cloud services, browser runtimes, workstations, mobile devices, embedded devices, robotics controllers, or distributed systems. Memory may include RAM, VRAM, unified memory, high-bandwidth memory, cache memory, persistent storage, object storage, project files, state stores, databases, vector databases, graph databases, audit logs, or network-accessible storage.

The source artificial intelligence execution environment, destination artificial intelligence execution environment, first assistant, application-native agent, compatibility manager, validation layer, handoff package generator, model task package generator, native agent interface, external model interface, result validator, result reconciliation engine, lineage graph manager, policy engine, authorization layer, target application, user interface, and audit system may execute on the same device or across multiple devices connected by a network. Communications may occur through local APIs, operating-system APIs, browser APIs, application APIs, plug-in interfaces, media editing APIs, design tool APIs, commerce APIs, model serving APIs, streaming protocols, project-file formats, cloud storage interfaces, message queues, event streams, deep links, local sockets, remote procedure calls, or other communication mechanisms.

The disclosed systems may be implemented as software, firmware, hardware, middleware, an operating system service, browser extension, cloud service, local daemon, AI assistant service, model-context server, application plug-in, media editor plug-in, design tool plug-in, workflow engine, enterprise automation platform, app store runtime, native app service, robotics middleware, or a combination thereof.

Computer software products may be written in any suitable programming language, including C, C++, C #, Java, JavaScript, TypeScript, Python, Go, Rust, Swift, Kotlin, PHP, Perl, Ruby, or combinations thereof. The software may be implemented as an independent application, service, class, distributed object, component software, serverless function, container, virtual machine, browser script, plug-in, or firmware component. The hardware may include general-purpose processors, GPUs, NPUs, TPUs, ASICs, FPGAs, DSPs, microcontrollers, memory controllers, network interface cards, smart NICs, DPUs, storage controllers, or combinations thereof.

### II. Methods for Compatibility-Based and AI Environment Handoff

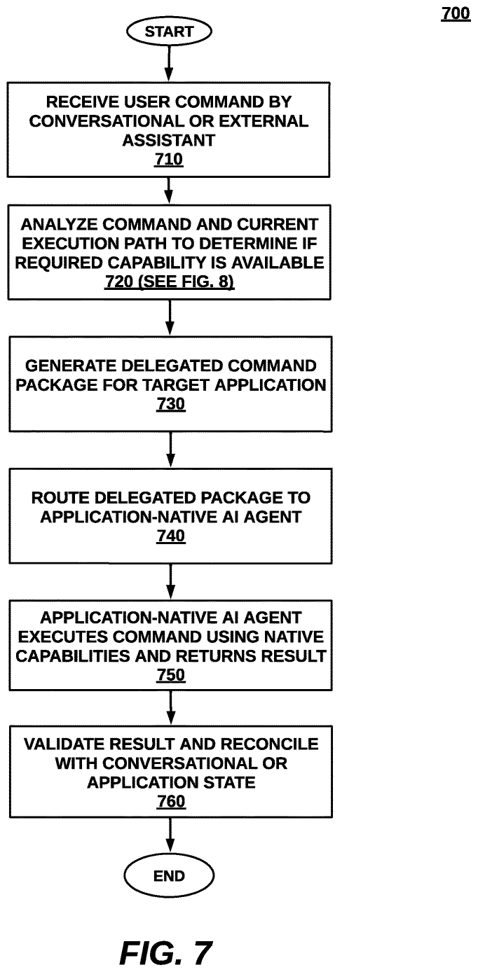

FIGS. 7-10 illustrate example methods for compatibility-based handoff of artificial intelligence commands, tasks, task state, and result information between artificial intelligence execution environments. Although the methods are described separately for clarity, steps from any method may be combined with steps from other methods, omitted, reordered, repeated, or performed by different components of the system. For example, a compatibility manager, validation layer, conversational assistant, application-native artificial intelligence agent, tool adapter, browser extension, operating-system service, workflow engine, cloud broker, model-context server, or target application endpoint may perform one or more of the steps described below.

### A. Forward Handoff From an External Assistant to an Application-Native AI Agent

FIG. 7 illustrates a method 700 for forward handoff from an external assistant to an application-native artificial intelligence agent, according to an embodiment. The method 700 may be performed when a conversational assistant, operating-system assistant, browser assistant, cloud assistant, workflow agent, or other source artificial intelligence execution environment understands a user instruction but lacks a native application capability needed to complete the instruction.

At step 710, the source artificial intelligence execution environment receives a user instruction or task associated with a software application. The instruction may be a natural-language instruction, multimodal instruction, tool-call request, editing request, website-building request, commerce request, design request, document request, development-environment request, media-editing request, robotics request, or other application-related task. In some embodiments, the source environment maintains conversational context, user intent, prior tool outputs, target application identity, target object identity, partial execution state, or policy metadata associated with the task.

At step 720, the source artificial intelligence execution environment analyzes a current execution path to determine whether a required capability is available. The current execution path may include an application programming interface, tool connector, browser automation interface, plug-in, local script, workflow engine, model-context endpoint, application adapter, operating-system service, validation layer, native-agent interface, or model-serving interface. The required capability may include a native editor operation, native timeline mutation, visual canvas binding, project-file mutation, transaction configuration, application-state access, object selection, unpublished draft access, or another application-native operation that is not available through the current execution path.

At step 730, the system determines that the task is valid in user intent but incompatible with the current execution path. The incompatibility may include execution-interface incompatibility, permission incompatibility, schema incompatibility, target-object unavailability, application-state incompatibility, visual-editor incompatibility, timeline-editor incompatibility, canvas incompatibility, version incompatibility, modality incompatibility, output-format incompatibility, or confidence incompatibility. In some embodiments, the determination distinguishes a task that should be blocked from a task that remains valid but requires delegation to a more suitable execution environment.

At step 740, the system generates a delegated command package for an application-native artificial intelligence agent. The delegated command package may include the user instruction, normalized task representation, target application identifier, target object identifier, incompatibility type, required native capability, completed sub-operations, partial execution trace, execution constraints, privacy constraints, authorization scope, output-format requirements, prohibited actions, validation rules, rollback information, success criteria, lineage metadata, branch metadata, and a return channel.

At step 750, the delegated command package is routed to an application-native artificial intelligence agent associated with the software application. The routing may occur through an application endpoint, plug-in, browser extension, local bridge, inter-process communication channel, cloud service endpoint, workflow broker, application-native agent interface, model-context server, or other communication path. The application-native artificial intelligence agent may access application state, project state, visual editor state, timeline state, canvas state, checkout state, unpublished draft state, native recommendation state, local session state, or another native capability unavailable to the source environment.

At step 760, the application-native artificial intelligence agent executes, previews, drafts, or otherwise processes the delegated command using native application capability and returns a result. The result may include completion status, partial completion status, structured result data, native operation output, preview, screenshot, diff, application-state change, failure reason, rollback token, audit identifier, or confirmation request. The source artificial intelligence execution environment, validation layer, compatibility manager, or reconciliation engine may validate the result and reconcile the result with conversational state or application state.

### B. Reverse Handoff From an Application-Native AI Agent to an External Model

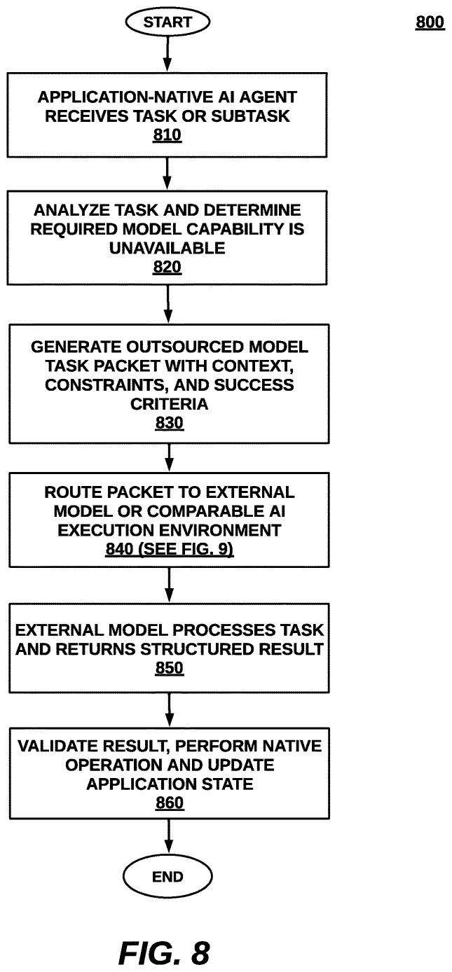

FIG. 8 illustrates a method 800 for reverse handoff from an application-native artificial intelligence agent to an external model, according to an embodiment. The method 800 may be performed when an application-native artificial intelligence agent has native application authority or state access but lacks a model capability needed to complete a task.

At step 810, an application-native artificial intelligence agent receives a user instruction, application task, subtask, candidate operation, project event, or workflow request associated with a software application. The application-native artificial intelligence agent may have access to native application state, target-object state, project files, timeline state, visual canvas state, user interface state, application permissions, transaction state, or application-specific actuators.

At step 820, the application-native artificial intelligence agent or an intermediary compatibility manager determines that completion of the task requires a model capability unavailable to the application-native artificial intelligence agent. The unavailable model capability may include long-context reasoning, natural-language planning, code generation, legal drafting, technical drafting, marketing copy generation, multimodal interpretation, summarization, translation, semantic classification, retrieval-augmented generation, ranking, policy reasoning, safety classification, domain-specific analysis, or generation of a structured command template.

At step 830, the system generates an outsourced model task package. The outsourced model task package may include a representation of the user instruction or application task, selected application state, target object information, unavailable model capability, required output schema, output-format requirements, success criteria, privacy constraints, redaction rules, authorization scope, prohibited actions, application-specific vocabulary, application-state identifiers, relevant project context, and validation rules. In some embodiments, the selected application state is redacted, summarized, transformed, tokenized, hashed, abstracted, or minimized before transmission to protect private or application-sensitive data.

At step 840, the outsourced model task package is transmitted to a second artificial intelligence execution environment comprising an external model. The external model may include a large language model, foundation model, domain-specific model, multimodal model, code model, local model, enterprise model, retrieval-augmented model, safety model, planning model, or validation model. In some embodiments, the external model lacks authority to directly mutate the software application and is limited to returning structured model output for later validation and native execution.

At step 850, the second artificial intelligence execution environment processes the outsourced model task package and returns a structured model result. The structured model result may include a proposed edit, plan, command template, generated content item, code fragment, validation result, semantic classification, ranked set of alternatives, reasoning artifact, tool-call template, policy assessment, or application-specific instruction.

At step 860, the application-native artificial intelligence agent, compatibility manager, validation layer, or reconciliation engine validates the structured model result and performs a native application operation based on the validated result. Validation may include schema validation, target-object validation, policy validation, authorization validation, privacy validation, hallucination validation, success-criteria validation, formatting validation, or user-confirmation checks. If validation succeeds, the application-native artificial intelligence agent may execute the native operation using authority retained inside the software application. If validation fails, the system may request a revised result, route to another model, ask for user confirmation, generate a preview, store a draft, or return a structured failure reason.

### C. Validation Layer Command Interception and Compatibility Resolution

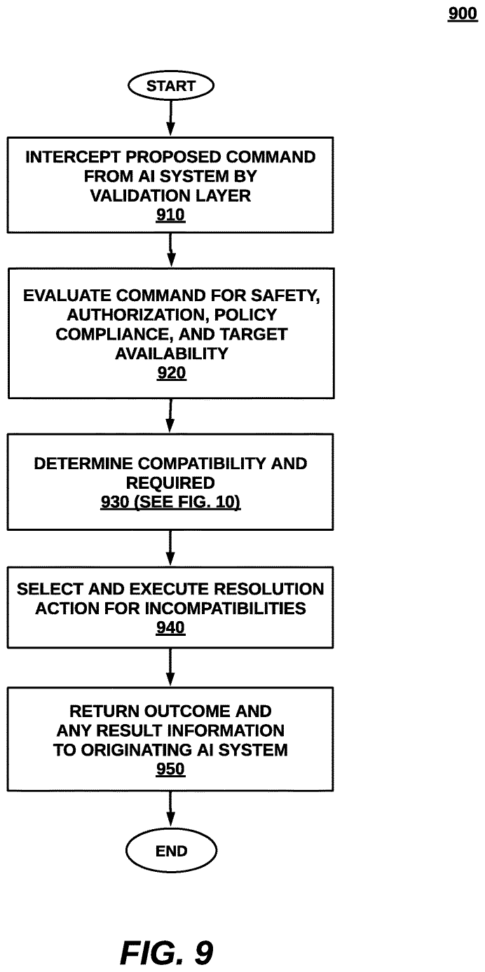

FIG. 9 illustrates a method 900 for validation layer command interception and compatibility resolution, according to an embodiment. The method 900 may be performed by a validation layer disposed between a chat artificial intelligence system and one or more software applications, tool interfaces, application-native agents, external models, or execution services.

At step 910, the validation layer intercepts a proposed command generated based on a user instruction. The proposed command may be generated by a chat artificial intelligence system, operating-system assistant, browser assistant, workflow agent, external model, application-native agent, or tool-calling model. The command may be intercepted before execution by an application, before transmission to an external model, before commitment to public content, before mutation of production data, before export of a media file, before execution of a transaction, or before control of a device or physical actuator.

At step 920, the validation layer evaluates the proposed command for safety, authorization, policy compliance, target-object availability, and execution compatibility. The evaluation may include syntactic validity, semantic validity, schema compatibility, application-state availability, execution-interface compatibility, model-capability compatibility, output-format compatibility, likely side effects, privacy sensitivity, confirmation requirements, rollback availability, and whether the command is consistent with user intent.

At step 930, the validation layer classifies a command status and an incompatibility type. In one embodiment, the validation layer determines whether the proposed command should be allowed, blocked, rewritten, decomposed, sandboxed, branched, confirmed, delegated, outsourced, locally processed, or rolled back. In another embodiment, the validation layer determines that the proposed command is valid in user intent but incompatible with a currently available execution interface. The incompatibility type may identify a missing native application capability, missing model capability, missing permission, unavailable target object, unavailable application state, privacy-policy limitation, or output-format mismatch.

At step 940, the validation layer selects a resolution action. The selected resolution action may include allowing the command, blocking the command, rewriting the command, decomposing the command into subcommands, routing the command to a sandbox environment, spawning a branch, requesting user confirmation, delegating the command to an application-native artificial intelligence agent, outsourcing the command to an external model, locally processing the command, or rolling back a prior operation. In some embodiments, the resolution action is selected based on a policy score, risk score, incompatibility type, user authority, application state, available destination environments, privacy constraints, latency requirement, or success criteria.

At step 950, the validation layer generates a resolution package and routes the resolution package according to the selected resolution action. For delegation to an application-native artificial intelligence agent, the package may include the natural language instruction, target object, incompatibility type, required native capability, execution constraints, validation rules, rollback instructions, and success criteria. For outsourcing to an external model, the package may include selected application state, required model capability, privacy constraints, output schema, and success criteria. For sandboxing or branching, the package may include branch state, shared-prefix state, branch-specific suffix state, preview requirements, or merge criteria.

At step 960, the validation layer receives an outcome and provides result information to the originating artificial intelligence system, user interface, application, or reconciliation engine. The outcome may include an allowed command, blocked command, rewritten command, delegated result, outsourced model result, sandbox preview, branch result, confirmation request, rollback result, or structured failure reason. The validation layer may update a lineage graph, audit log, policy record, branch record, application state, conversational state, or user-visible explanation based on the outcome. In some embodiments, the conversation outcome is continued in the native application with direct tools rather than returning to general artificial intelligence.

### D. Compatibility-Based Handoff With State Reconciliation

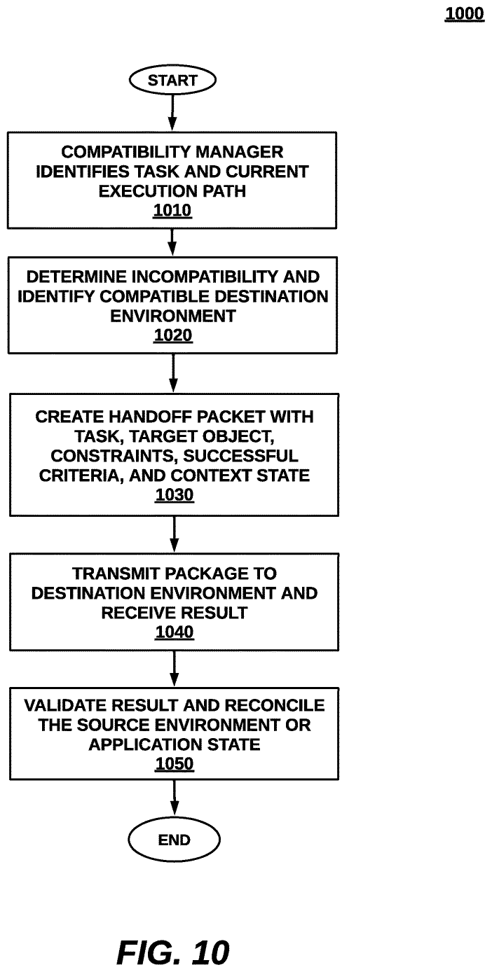

FIG. 10 illustrates a method 1000 for compatibility-based handoff with state reconciliation, according to an embodiment. The method 1000 may be used to preserve continuity when a task is transferred from one artificial intelligence execution environment to another and a result is later returned.

At step 1010, a compatibility manager identifies a task and a current execution path associated with a source artificial intelligence execution environment. The source artificial intelligence execution environment may include a general conversational assistant, operating-system assistant, browser assistant, workflow agent, cloud assistant, application-native artificial intelligence agent, local model, remote model, media editor agent, website builder agent, commerce agent, integrated development environment agent, robotics controller agent, or another artificial intelligence runtime. The task may be associated with an application state, conversation state, target object, user instruction, branch state, partial execution trace, or tool-call history.

At step 1020, the compatibility manager determines that the task is incompatible with the current execution path and identifies a compatible destination artificial intelligence execution environment. The destination environment may include an application-native artificial intelligence agent, external large language model, foundation model, domain-specific model, multimodal model, code model, local model, enterprise model, safety classifier, planning model, validation model, operating-system service, application endpoint, model-context server, or another artificial intelligence runtime. Compatibility may be determined based on native authority, model capability, target-object access, application-state access, schema support, permission scope, privacy constraints, execution interface, latency, confidence, version compatibility, or output-format compatibility.

At step 1030, the compatibility manager or handoff package generator creates a handoff package. The handoff package may include a task representation, user intent, normalized command, source environment identifier, destination environment identifier, target application identifier, target object identifier, completed sub-operations, partial execution trace, missing capability classification, required native capability, required model capability, execution constraints, privacy constraints, authorization scope, output-format requirements, prohibited actions, rollback instructions, success criteria, validation rules, lineage metadata, branch metadata, policy metadata, shared-prefix state, branch-specific suffix state, and a return channel.

At step 1040, the handoff package is transmitted to the destination artificial intelligence execution environment and a result is received. The result may include completion status, partial completion status, structured output, proposed edit, command template, generated content, code fragment, validation result, semantic classification, ranked alternative set, reasoning artifact, preview, screenshot, diff, failure reason, rollback token, audit identifier, confirmation request, or application-state delta.

At step 1050, the result is validated before being reconciled with the source environment or the software application. Validation may include policy validation, authorization validation, target-object validation, schema validation, privacy validation, hallucination validation, formatting validation, success-criteria validation, side-effect validation, rollback validation, or user-confirmation checks. In some embodiments, validation is performed before committing a change to public content, production data, a transaction system, published website, exported media file, external communication, or physical actuator.

At step 1060, the result is reconciled with the source artificial intelligence execution environment, the software application, or both. Reconciliation may include updating conversational state, updating application state, generating a preview, presenting a diff, requesting confirmation, committing a native change, storing a draft, issuing a rollback, retrying with another destination environment, returning a structured failure reason, updating a lineage graph, updating branch state, updating a task graph, or recording an audit entry. In this manner, a user may experience a continuous workflow even though execution of the task was transferred across artificial intelligence execution environments.

### III. Generalities

The foregoing description is illustrative and not limiting. A component described as a first artificial intelligence assistant may be a source artificial intelligence execution environment of any type. A component described as an application-native artificial intelligence agent may be a destination artificial intelligence execution environment or a source artificial intelligence execution environment depending on direction of handoff. A component described as an external large language model may be local, remote, enterprise-hosted, cloud-hosted, on-device, open-source, proprietary, multimodal, code-focused, retrieval-enhanced, fine-tuned, distilled, or domain-specific.

The term command may include a tool call, application call, function call, script, prompt, task, branch instruction, workflow step, macro, application intent, operating-system action, API request, model request, native operation, media edit, document edit, commerce operation, robotic action, or other executable or semi-executable representation. The term incompatibility may refer to an inability, undesirability, restriction, risk, policy mismatch, missing capability, or low-confidence condition associated with the current execution path.

A handoff may be forward, reverse, lateral, multi-hop, recursive, or branched. A general assistant may delegate to a native agent. A native agent may outsource to an external model. An external model may return a result to a validation layer. A validation layer may route to a local model instead of a public cloud model. A workflow engine may split a task among multiple app-native agents and multiple external models. Multiple handoffs may occur within a single user task.

The validation layer is an important embodiment but is not required. Functions described as performed by a validation layer may be performed by a source assistant, native agent, target application, tool adapter, operating-system service, browser extension, cloud broker, model gateway, enterprise governance service, workflow engine, local daemon, or other component. Conversely, functions described as performed outside a validation layer may be incorporated into a validation layer.

The disclosed systems may be used with websites, content management systems, video editors, audio editors, design tools, music applications, productivity applications, word processors, spreadsheets, slide editors, email clients, calendars, customer relationship management systems, commerce platforms, payment systems, shipping systems, code editors, development environments, operating systems, mobile applications, enterprise workflow systems, robotics systems, autonomous vehicle systems, smart-home systems, industrial systems, medical systems, legal systems, and other software or device systems.

Security, privacy, and policy controls may be applied at any stage. A handoff package may be minimized, redacted, encrypted, signed, watermarked, sandboxed, constrained to preview mode, limited to a target object, time-limited, scope-limited, or subject to confirmation. Returned results may be validated before execution. Execution may be blocked, quarantined, delayed, rewritten, decomposed, delegated, sandboxed, branched, or rolled back.

The examples described herein are not exhaustive. Steps may be performed in a different order. Components may be combined or separated. Local components may be remote, and remote components may be local. A single processor may perform multiple functions, or multiple processors may perform a single function. Many other embodiments are possible.

Many other embodiments are possible.

I claim:

1. A computer-implemented method comprising:
receiving, by a source artificial intelligence execution environment, a task associated with a software application;
identifying a current execution path available to the source artificial intelligence execution environment;
determining, by one or more processors, that the task is incompatible with the current execution path and compatible with a destination artificial intelligence execution environment;
classifying an incompatibility type associated with the task;
generating a handoff package comprising a representation of the task, an identifier of the software application, an identifier of a target object associated with the task, the incompatibility type, a required capability of the destination artificial intelligence execution environment, one or more execution constraints, and one or more success criteria;
transmitting the handoff package to the destination artificial intelligence execution environment;
receiving a result from the destination artificial intelligence execution environment; and
reconciling the result with a state of the source artificial intelligence execution environment or the software application.

2. The method of claim 1, wherein the source artificial intelligence execution environment comprises a conversational assistant, operating-system assistant, browser assistant, cloud workflow agent, or general external assistant, and wherein the destination artificial intelligence execution environment comprises an application-native artificial intelligence agent associated with the software application.

3. The method of claim 1, wherein the source artificial intelligence execution environment comprises an application-native artificial intelligence agent associated with the software application, and wherein the destination artificial intelligence execution environment comprises an external large language model, foundation model, domain-specific model, multimodal model, code model, local model, or enterprise model.

4. The method of claim 1, wherein the incompatibility type comprises at least one of execution-interface incompatibility, schema incompatibility, permission incompatibility, visual-editor incompatibility, timeline-editor incompatibility, canvas incompatibility, application-state incompatibility, native-recommendation incompatibility, version incompatibility, modality incompatibility, model-capability incompatibility, context-window incompatibility, domain-knowledge incompatibility, privacy-policy incompatibility, output-format incompatibility, or confidence incompatibility.

5. The method of claim 1, wherein the current execution path comprises an application programming interface, tool connector, browser automation interface, plug-in, local script, workflow engine, model-context endpoint, application adapter, operating-system service, validation layer, native-agent interface, or model-serving interface.

6. The method of claim 1, wherein the handoff package further comprises a partial execution trace identifying one or more sub-operations already performed before determining that the task is incompatible with the current execution path.

7. The method of claim 1, wherein the handoff package further comprises privacy constraints, authorization scope, output-format requirements, prohibited actions, validation rules, rollback information, lineage metadata, branch metadata, or a return channel.

8. The method of claim 1, further comprising validating the result before committing a change to public content, production data, a transaction system, a published website, an exported media file, an external communication, or a physical actuator.

9. The method of claim 1, further comprising maintaining a lineage graph linking a user instruction, the source artificial intelligence execution environment, the handoff package, the destination artificial intelligence execution environment, the result, and an operation performed using the result.

10. The method of claim 1, wherein reconciling the result comprises updating a conversational state, updating an application state, generating a preview, presenting a diff, requesting confirmation, committing a native change, storing a draft, issuing a rollback, retrying with another destination artificial intelligence execution environment, or returning a structured failure reason.

11. A computer-implemented method comprising:
intercepting, by a validation layer disposed between a chat artificial intelligence system and a target software application, a proposed command generated based on a natural-language user instruction;
evaluating, by the validation layer, the proposed command for safety, authorization, policy compliance, target-object availability, and compatibility with a currently available execution interface;
determining, by the validation layer, that the proposed command is valid in user intent and incompatible with the currently available execution interface;
selecting, by the validation layer, a resolution action comprising delegation to an application-native artificial intelligence agent associated with the target software application;
generating, by the validation layer, a delegated command package comprising the natural-language user instruction, a target object, an incompatibility type, a required native capability, one or more execution constraints, and one or more success criteria;
routing, by the validation layer, the delegated command package to the application-native artificial intelligence agent;
receiving, by the validation layer, an execution result from the application-native artificial intelligence agent; and
providing, by the validation layer, result information to the chat artificial intelligence system.

12. The method of claim 11, wherein the validation layer is further configured to select among resolution actions comprising allowing the proposed command, blocking the proposed command, rewriting the proposed command, decomposing the proposed command, sandboxing the proposed command, branching the proposed command, requesting user confirmation, delegating to the application-native artificial intelligence agent, outsourcing to an external model, locally processing the proposed command, or rolling back the proposed command.

13. The method of claim 11, further comprising generating a branch-consistent task state comprising a shared-prefix task state inherited by a plurality of execution branches and a branch-specific suffix state corresponding to the delegated command package.

14. The method of claim 13, wherein the shared-prefix task state comprises conversation context, target-application identity, target-object discovery, completed operations, user preferences, authorization data, or policy metadata, and wherein the branch-specific suffix state comprises the required native capability and an unresolved native operation.

15. A system comprising:
one or more processors;
memory coupled to the one or more processors;
a compatibility manager configured to identify a task generated or received by a source artificial intelligence execution environment and determine that the task is incompatible with a current execution path and compatible with a destination artificial intelligence execution environment;
a handoff package generator configured to generate a handoff package comprising a representation of the task, incompatibility metadata, target-object information, a required capability, one or more constraints, and one or more success criteria;
an interface configured to transmit the handoff package to the destination artificial intelligence execution environment and receive a result; and
a reconciliation engine configured to validate the result and update a state of the source artificial intelligence execution environment or a software application based on the result.

16. The system of claim 15, wherein the source artificial intelligence execution environment comprises a cloud-hosted general assistant or a locally executing general artificial intelligence model, and wherein the destination artificial intelligence execution environment comprises a local application-native artificial intelligence agent or a cloud-hosted application-native artificial intelligence agent.

17. The system of claim 15, further comprising a validation failure detector configured to detect a hallucination condition, grounding failure, missing-source condition, citation failure, schema failure, factual-consistency failure, target-object mismatch, low-confidence condition, unsupported inference, or failure to satisfy one or more success criteria associated with an output of the source artificial intelligence execution environment.

18. The system of claim 15, wherein the handoff package comprises branch state, shared-prefix state, branch-specific suffix state, tool-result state, retrieval state, lineage metadata, policy metadata, authorization scope, rollback instructions, validation rules, or a return channel.

19. The system of claim 15, wherein the interface is configured to transmit the handoff package through an application programming interface, model-context protocol interface, remote procedure call interface, browser extension, plug-in interface, operating-system service, workflow broker, inter-process communication channel, message queue, direct software development kit interface, cloud service endpoint, or local bridge.

20. The system of claim 15, wherein the reconciliation engine is configured to update conversational state, update application state, generate a preview, present a diff, request confirmation, commit a native change, store a draft, issue a rollback, retry with another destination artificial intelligence execution environment, update a lineage graph, update branch state, or return a structured failure reason.
